(19) United States
(12) Patent Application Publication
(10) Pub. No.: US 2016/0050883 A1
(43) Pub. Date: Feb. 25, 2016

(54) Texas Haynet

(71) Applicant: Lone Star Innovations, LLC, Baldwyn, MS (US)

(72) Inventor: Leslie W. Davis, Spicewood, TX (US)

(73) Assignees: LONE STAR INNOVATIONS, LLC, Baldwyn, MS (US); Leslie W. Davis

(21) Appl. No.: 14/929,585

(22) Filed: Nov. 2, 2015

Related U.S. Application Data
(63) Continuation-in-part of application No. 12/932,763, filed on Mar. 7, 2011, now abandoned.

(51) Int. Cl. A01K 5/00; A01K 1/10

(52) U.S. Cl. CPC A01K 5/00; A01K 1/10

(57) ABSTRACT

The Texas haynet is a durable net configured to fit over a hay bale, where the holes within the net are sufficiently large enough to allow livestock to eat the hay through the holes yet small enough to restrict the rate at which the hay is eaten, so as to reduce the rate livestock eat, which improves digestion.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC

Not Applicable

### DESCRIPTION

### Field of the Invention

The texas haynet is a net with specifically sized holes designed to cover a hay bale that has been placed out for livestock to feed upon. The intent of the texas haynet is to cause livestock to draw the hay of the hay bale through the holes in the net before the food can be eaten, so as to cause livestock to eat more slowly in order to improve digestion and decrease the likelihood of certain diseases. To accomplish the desired goal, the net is made of material durable enough to withstand the bite from the livestock yet soft enough so as not to irritate the nose of the livestock during eating, which would otherwise discourage eating. The holes within the net are so dimensioned as to be large enough to allow the animal to feed through yet small enough to reduce the rate at which the animal eats, for example, 1.75 inches and 2.0 inches on a side which have been identified as causing the desired effect for horses.

### BACKGROUND OF THE INVENTION

This application is a continuation in part of U.S. patent application Ser. No. 12/0,227,671 filed Mar. 7, 2011. The benefit of the earlier filing date of the aforementioned U.S. patent application Ser. No. 12/0,227,671 is hereby claimed.

The texas haynet was created in response to research that demonstrated that when horses eat more slowly, they are less susceptible to diseases such as laminitis. Specifically, if horses were forced to eat through 2″ holes, they would eat more slowly, which then limits the warming effects of rapid ingestion of proteins that would otherwise provide a favorable environment for toxins to develop in the hooves of the horse. The challenge is to develop a method of slowing ingestion by livestock that was inexpensive, but which would made from material that would be sufficiently durable to resist exposure to the elements and the impact of frequent biting (given that a horse bite delivers pressure in excess of 2,000 pounds per inch), while the material would be sufficiently soft and pliable so as to not discourage the livestock from eating. The netting with which hay bale rolls are bound when they are harvested have been used to support the binding of hay to keep its shape, but this netting is not sufficiently durable for long term use as it breaks easily. Several attempts have been made to create a means to restrict the rate at which livestock eat, all of which can be distinguished from the present disclosure.

### SUMMARY OF THE INVENTION

The texas haynet is a net designed to be placed over a roll of hay to restrict livestock to eating through the holes in the net, where the holes act to restrict the rate at which livestock eat. The holes within the net are so dimensioned as to be large enough to allow the animal to feed through yet small enough to reduce the rate at which the animal eats. The material with which the texas haynet is made is sufficiently durable to resist exposure to the elements and the impact of frequent biting by the livestock, while the material would be sufficiently soft and pliable so as to not discourage the livestock from eating.

The first embodiment of the texas haynet comprises a net of sufficient size to cover the hay bale (exclusive of the underside), where the material with which the net is made is of sufficient durability to resist exposure to the elements and the impact of frequent biting by the livestock, where the holes within the net are so dimensioned as to be large enough to allow the animal to feed through yet small enough to reduce the rate at which the animal eats.

The second embodiment of the texas haynet comprises a net of sufficient size to cover the hay bale (exclusive of the underside), where the material with which the net is made is of sufficient durability to resist exposure to the elements and the impact of frequent biting by the livestock, where the holes within the net are so dimensioned as to be large enough to allow the animal to feed through yet small enough to reduce the rate at which the animal eats, where in addition to the material for the net there are a plurality of additional ropes woven through the net in such a fashion that, once the net is draped over the hay bale, these additional plurality of ropes are drawn tight so that the net assists in holding the form of the hay bale together.

The third embodiment of the texas haynet comprises a net of sufficient size to cover the hay bale (exclusive of the underside), where the material with which the net is made is of sufficient durability to resist exposure to the elements and the impact of frequent biting by the livestock, where the holes within the net are so dimensioned as to be large enough to allow the animal to feed through yet small enough to reduce the rate at which the animal eats, where in addition to the material for the net there are a plurality of contracting ropes woven through the net in such a fashion that, once the net is draped over the hay bale, these additional plurality of ropes contract so that the net assists in holding the form of the hay bale together.

Each embodiment of the texas haynet may also comprise a plurality of centering ropes that are woven through the texas haynet from edge to edge and through the center, wherein these plurality of centering ropes aid in ensuring the entire hay bale is covered by the texas haynet.

### BRIEF DESCRIPTION OF THE SEVERAL VIEWS OF THE DRAWING

FIG. 1 is a view of the texas haynet over a hay bale;

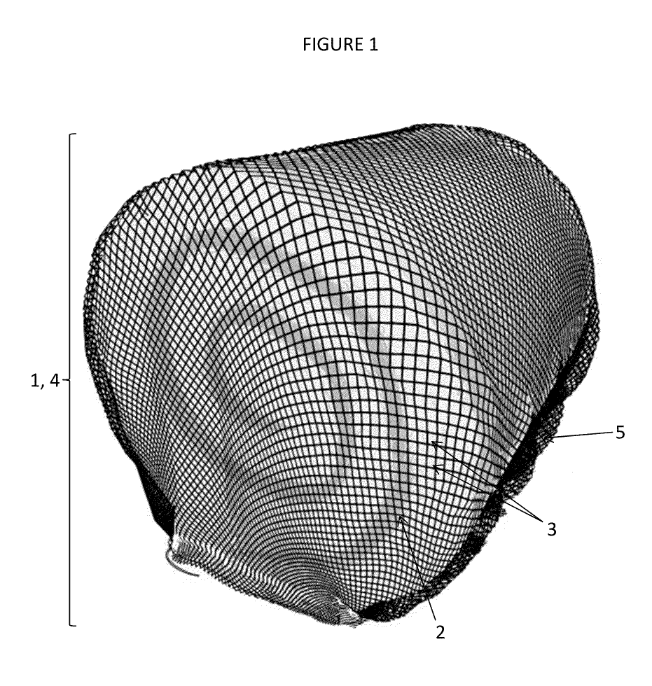

FIG. 2 is a view of the first embodiment of the texas haynet including the net, the material that makes up the net, and the holes in the net;

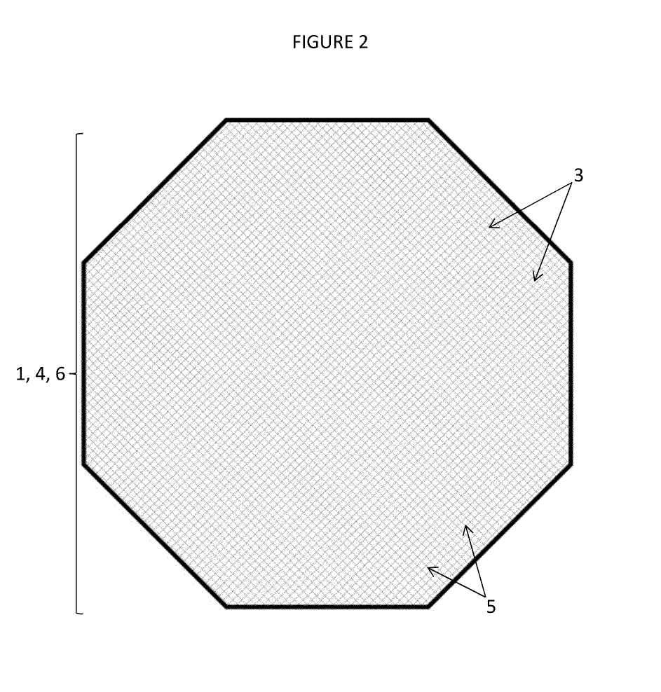

FIG. 3 is a view of the second embodiment of the texas haynet additionally including the plurality of additional ropes that are used to draw the texas haynet against the hay bale; and

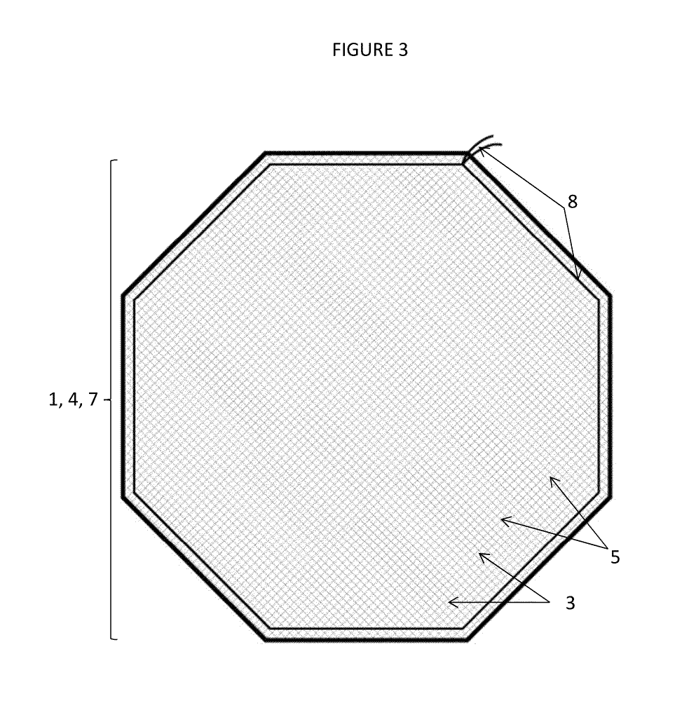

FIG. 4 is a view of the third embodiment of the texas haynet additionally including the plurality of contracting ropes that are used to contract the texas haynet against the hay bale; and

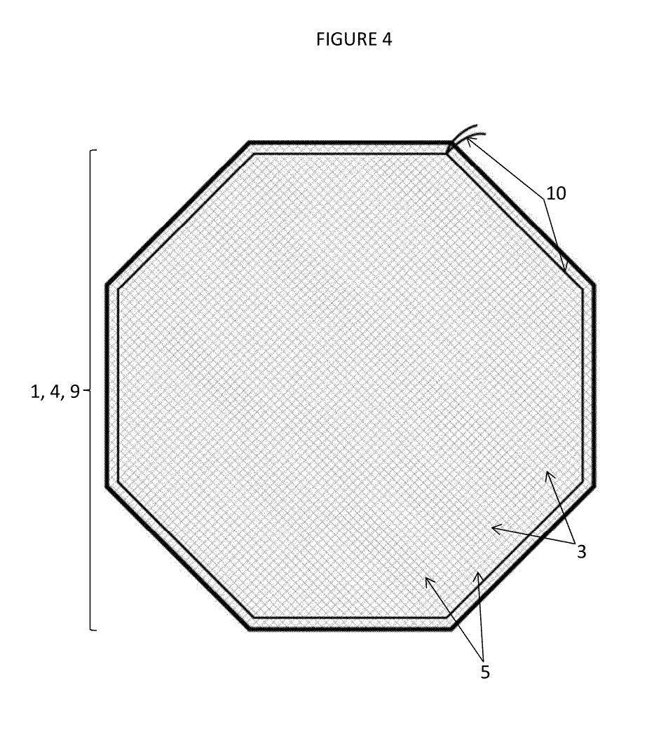

FIG. 5 is a view of the first embodiment of the texas haynet additionally including a plurality of centering ropes;

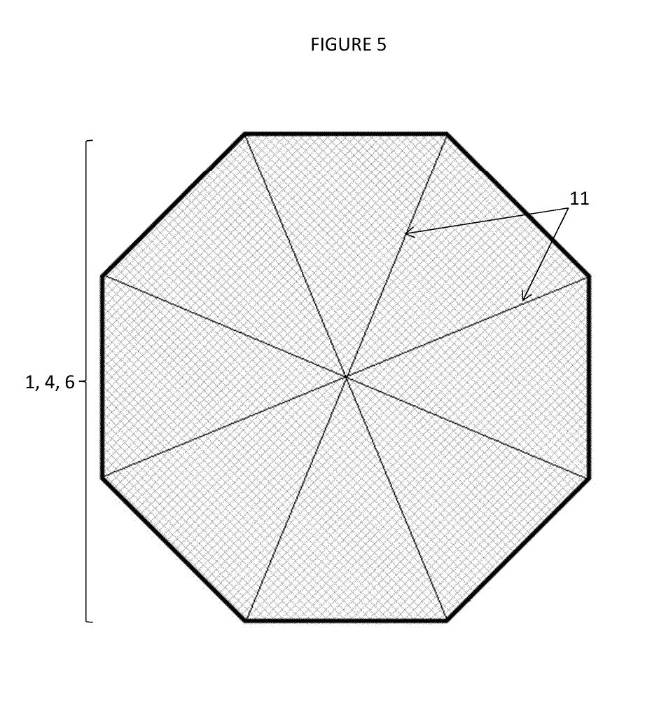

FIG. 6 is a view of the second embodiment of the texas haynet additionally including a plurality of centering ropes; and

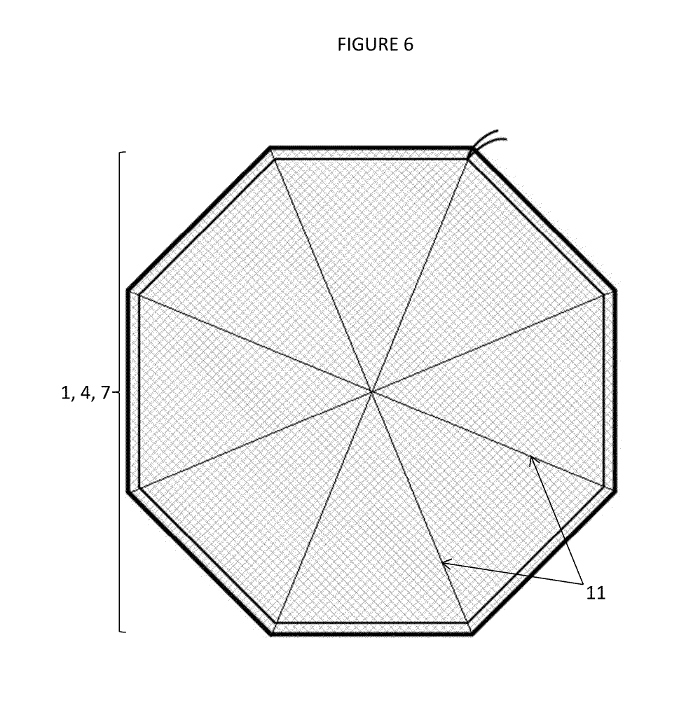

FIG. 7 is a view of the third embodiment of the texas haynet additionally including a plurality of centering ropes.

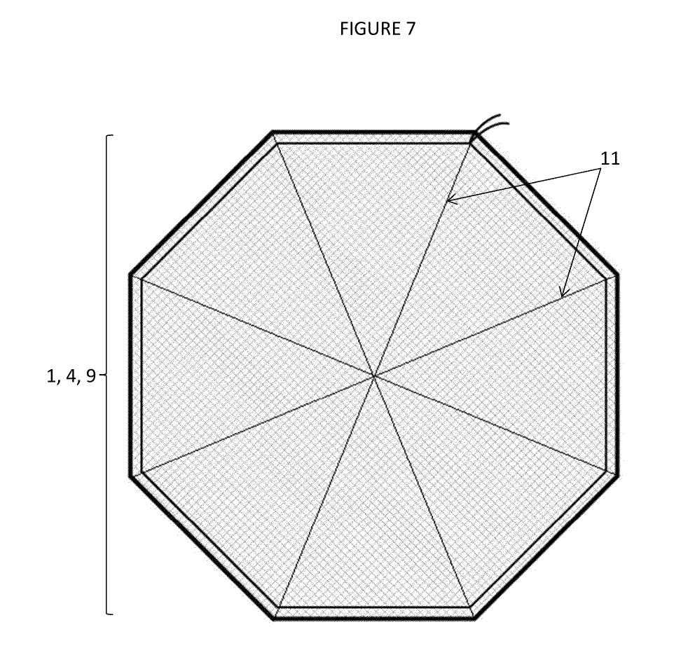

### DETAILED DESCRIPTION OF THE INVENTION

The texas haynet 1 is a net designed to be placed over a hay bale 2 to restrict livestock to eating through specifically sized holes 3 in the net 4, which slows down the rate at which the livestock eat and improves digestion. The material 5 with which the net 4 is made is sufficiently durable resist exposure to the elements and the impact of frequent biting by the livestock, while the material 5 is sufficiently soft and pliable so as to not discourage the livestock from eating.

The first embodiment 6 of the texas haynet 1 comprises a net 4 of sufficient size to cover the hay bale (exclusive of the underside), where the material 5 with which the net 4 is made is of sufficient durability to resist exposure to the elements and the impact of frequent biting by the livestock, where the holes 3 within the net 2 are so dimensioned as to be large enough to allow the animal to feed through them yet small enough to restrict the rate at which the animal eats.

The second embodiment 7 of the texas haynet 1 comprises a net 4 of sufficient size to cover the hay bale (exclusive of the underside), where the material 5 with which the net 4 is made is of sufficient durability to resist exposure to the elements and the impact of frequent biting by the livestock, where the holes 3 within the net 4 are so dimensioned as to be large enough to allow the animal to feed through them yet small enough to reduce the rate at which the animal eats, where in addition to the material 5 for the net 4 there are a plurality of additional ropes 8 woven through the net 4 in such a fashion that, once the net 4 is draped over the hay bale, these plurality of additional ropes 8 can be drawn tight so that the net assists in holding the hay bale together.

The third embodiment 9 of the texas haynet 1 comprises a net 4 of sufficient size to cover the hay bale (exclusive of the underside), where the material 5 with which the net 4 is made is of sufficient durability to resist exposure to the elements and the impact of frequent biting by the livestock, where the holes 3 within the net 4 are so dimensioned as to be large enough to allow the animal to feed through them yet small enough to reduce the rate at which the animal eats, where in addition to the material 5 for the net 4 there are a plurality of contracting ropes 10 woven through the net 4 made of an elastic material such that, once the net 4 is draped over the hay bale, these plurality of contracting ropes 10 hold the net 4 against the hay bale and contract as the hay bale is being consumed, so as to aid in holding the hay bale together during consumption.

In addition to the above mentioned embodiments for the texas haynet 1, the first embodiment 6, second embodiment 7, and third embodiment 9 may have a plurality of centering ropes 11 weaved through the net 4 from edge to edge and through the center, wherein these plurality of centering ropes 11 aid in ensuring the net 4 is centered over the hay bale 2 and the entire hay bale 2 is covered by the net 4.

What is claimed:

1. A texas haynet for the purpose of restricting the rate livestock eat in order to improve digestion comprising:
a net of sufficient size to entirely cover a hay bale, exclusive of the underside;
where the material with which the net is made is of sufficient durability to resist exposure to the elements and the impact of frequent biting by the livestock while sufficiently soft and pliable so as to not discourage livestock from eating; and
where the holes within the net are so dimensioned as to be large enough to allow the animal to feed through them yet small enough to reduce the rate at which the animal eats.

2. The texas haynet of claim 1 where there are a plurality of centering ropes woven through the net from edge to edge and through the center, wherein these plurality of centering ropes aid in ensuring the net is centered over the hay bale and the entire hay bale is covered by the net.

3. The texas haynet of claim 1 where there are a plurality of additional ropes woven through the net in such a fashion that, once the net is draped over the hay bale, these plurality of additional ropes can be drawn tight so that the net assists in holding the hay bale together.

4. The texas haynet of claim 3 where there are a plurality of centering ropes woven through the net from edge to edge and through the center, wherein these plurality of centering ropes aid in ensuring the net is centered over the hay bale and the entire hay bale is covered by the net.

5. The texas hay net of claim 1 there are a plurality of contracting ropes woven through the net made of an elastic material such that, once the net is draped over the hay bale, these plurality of additional ropes hold the net against the hay bale and contract as the hay bale is being consumed, so as to aid in holding the hay bale together during consumption.

6. The texas haynet of claim 5 where there are a plurality of centering ropes woven through the net from edge to edge and through the center, wherein these plurality of centering ropes aid in ensuring the net is centered over the hay bale and the entire hay bale is covered by the net.
